(19) United States
(12) Patent Application Publication
(10) Pub. No.: US 2025/0370558 A1
(43) Pub. Date: Dec. 4, 2025

(54) ARBITRATION OF TOUCH INPUT BASED ON DEVICE SCREEN STATE

(71) Applicant: GOOGLE LLC, Mountain View, CA (US)

(72) Inventors: Ishan Chatterjee, Seattle, WA (US); Karan Ahuja, Seattle, WA (US); Eric Jordan Gonzalez, Seattle, WA (US)

(21) Appl. No.: 18/732,105

(22) Filed: Jun. 3, 2024

(51) Int. Cl. G06F 3/041

(52) U.S. Cl. CPC G06F 3/0416

(57) ABSTRACT

According to at least one implementation, a method includes identifying a screen state associated with a first device and determining whether the screen state associated with the first device satisfies at least one criterion. In response to determining that the screen state associated with the first device satisfies the at least one criterion, the method further includes identifying touch input for a second device at the first device. In response to determining that the screen state associated with the first device fails to satisfy the at least one criterion, the method further includes identifying touch input for the first device at the first device.

### BACKGROUND

An extended reality (XR) device incorporates a spectrum of technologies that blend physical and virtual worlds, including virtual reality (VR), augmented reality (AR), and mixed reality (MR). These devices immerse users in digital environments, either by blocking out the real world (VR), overlaying digital content onto the real world (AR), or blending digital and physical elements seamlessly (MR). XR devices that include headsets, glasses, or screens equipped with sensors, cameras, and displays that track movement of users and surroundings to deliver immersive experiences across various applications such as gaming, education, healthcare, and industrial training.

### SUMMARY

This disclosure relates to systems and methods for arbitrating touch input from a touch device to either the touch device or a second device, such as an extended reality (XR) device. In some implementations, the touch device may represent a smartphone, smartwatch, tablet, or some other touch device. In some implementations, the second device may represent an XR device or some other wearable device. In at least one implementation, an application determines whether to assign touch input from a touch device to the touch device itself or a second device based on the screen state associated with the touch device. The application may execute on the touch device, the second device, or some combination thereof. When the screen state satisfies at least one criterion, indicating the user is not actively interacting with content displayed by the touch device, then touch input from the touch device may be provided to the XR device. However, when the screen state does not satisfy the at least one criterion, indicating the user is actively interacting with content on the touch device, then touch input at the touch device may be assigned to the touch device. Touch input on the touch device is used for providing a direct and intuitive input to either the touch device or the second device. Touch input allows users to navigate interfaces, enter data, and control applications through simple gestures like tapping, swiping, and pinching.

In some aspects, the techniques described herein relate to a method including: identifying a screen state associated with a first device; determining whether the screen state associated with the first device satisfies at least one criterion; in response to determining that the screen state associated with the first device satisfies the at least one criterion, identifying touch input for a second device at the first device; and in response to determining that the screen state associated with the first device fails to satisfy the at least one criterion, identifying touch input for the first device at the first device.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the at least one processor to: identify a screen state associated with a first device; determine that the screen state associated with the first device satisfies at least one criterion; in response to determining that the screen state associated with the first device satisfies the at least one criterion, identify touch input for a second device at the first device; and in response to determining that the screen state associated with the first device fails to satisfy the at least one criterion, identify touch input for the first device at the first device.

In some aspects, the techniques described herein relate to a computer-readable storage medium having program instructions stored thereon that, when executed by at least one processor, cause the at least one processor to execute operations, the operations including: identifying a screen state associated with a first device; determining whether the screen state associated with the first device satisfies at least one criterion; in response to determining that the screen state associated with the first device satisfies the at least one criterion, identifying touch input for a second device at the first device; and in response to determining that the screen state associated with the first device fails to satisfy the at least one criterion, identifying touch input for the first device at the first device.

The details of one or more implementations are set forth in the accompanying drawings and the description below. Other features will be apparent from the description and drawings, and from the claims.

### BRIEF DESCRIPTION OF THE DRAWINGS

FIG. 1 illustrates a system for assigning touch input based on screen state according to an implementation.

FIG. 2 illustrates a method of assigning touch input based on screen state of a touch device according to an implementation.

FIG. 3 illustrates an operational scenario of assigning touch input from a touch device according to an implementation.

FIG. 4 illustrates an operational scenario of assigning touch input from a touch device according to an implementation.

FIG. 5 illustrates a method of displaying notifications based on the screen state of a touch device according to an implementation.

FIG. 6 illustrates an operational scenario of assigning touch input based on screen state and application state of devices according to an implementation.

FIG. 7 illustrates an operational scenario of assigning input based on recent touch input according to an implementation.

FIG. 8 illustrates a computing system to assign touch input based at least on the screen state according to an implementation.

### DETAILED DESCRIPTION

Computing devices, such as wearable devices and extended reality (XR) devices, provide users with an effective tool for gaming, training, education, healthcare, and more. An extended reality (XR) device merges the physical and virtual worlds, encompassing virtual reality (VR), augmented reality (AR), and mixed reality (MR) experiences. These devices usually include headsets or glasses equipped with sensors, cameras, and displays that track users' movements and/or surroundings, allowing them to interact with digital content in real-time. XR devices offer immersive experiences by either completely replacing the real world with a virtual one (VR), overlaying digital information onto the real world (AR), or seamlessly integrating digital and physical elements (MR). Input to XR devices may be provided through a combination of physical gestures, voice commands, controllers, and/or eye movements. Users interact with the virtual environment by manipulating objects, navigating menus, and/or triggering actions using these input methods, which are translated by the device's sensors and algorithms into corresponding digital interactions within the XR space. However, at least one technical problem with current input methodologies includes the inability to provide precise and efficient inputs to the XR device.

At least one technical solution to the technical problem described above includes using a companion device to provide precise and efficient inputs to an XR device, as described herein. Many users possess and use a variety of companion devices (referred to herein as “touch devices”), such as smartphones, smartwatches, and tablets, which can be handheld electronic devices equipped with a touchscreen interface that allows users to interact with the device by directly touching the screen with their fingers or a stylus. Through intuitive gestures such as tapping, swiping, pinching, and so forth, users can navigate through menus, launch applications, input text, and/or manipulate on-screen elements.

At least one technical solution includes an application configured to assign touch inputs from a touch device to the XR device when criteria are met. In at least one implementation, the application is configured to execute on the touch device and/or the XR device. The application may include a function or a set of functions that run in the background to support the touch input arbitration to multiple devices. The application may not have a user interface in some examples. As at least one example, the application may monitor the screen state of the device. In some examples, the screen state indicates whether the screen is active or inactive. In some examples, a screen is considered active when it is powered on and displaying content, responding to input either from a user (e.g., touch input), a connected device (e.g., controller), or some other input. The screen may remain active as long as it is engaged in these functions, such as when being used to view information, interact with apps, or process tasks. For example, when a user is reading an article on the touch device, the screen may stay in an active state while the user continues to provide input or until the user locks the device. In some examples, the screen is considered inactive when there is no user interaction or display changes occurring within a defined period, typically determined by a lack of input or activity for a preset duration. It is often indicated by the screen being off, a screensaver activating or the display (e.g., displaying time in an always on configuration), or dimming to conserve energy. When the screen is active, touch input at the touch device will be provided to the touch device. However, when the screen is considered inactive, touch input at the touch device will be provided to the second computing device (e.g., the XR device). As at least one technical effect, the touch device can be used to provide touch input to multiple devices and provide an effective tool for interacting with computing devices, such as XR devices.

At least another technical solution includes an application configured to determine where to assign touch input based on the touch status associated with the touch device. In some implementations, the application is configured to determine a touch status associated with the touch device based on one or more most recent touch inputs provided to the touch device. Touch inputs on a touch device refer to interactions made by physically touching the screen, typically through gestures like tapping, swiping, or pinching. These inputs are converted into commands by the device's software, enabling users to interact with applications, games, and interfaces. For example, a user may drag their finger to scroll a list of files. Based on the most recent one or more touch inputs, the application may determine whether to direct touch input to the touch device or to the second computing device (e.g., XR device). Thus, when the touch input indicates that it corresponds to content or an application executing on the touch device, touch input will be directed to the touch device. Otherwise, when touch input does not indicate that it corresponds to an application on the touch device, then the touch input will be directed to the second computing system. For example, touch input that indicates a scroll of files in a file management application on the touch device will indicate that the user is actively providing input in association with the touch device. Accordingly, touch input will be provided to the touch device based on the touch input. However, if a touch input does not indicate that it corresponds to the touch device (e.g., indicates a scroll input when scroll is not an option based on the display), then touch input will be directed to the second computing device. As at least one technical effect, the touch device may be used to provide input both to applications executing on the touch device and applications executing on a second computing device based on the determined intent of the user.

Various embodiments of the present technology provide for a wide range of technical effects, advantages, and/or technical solutions for computing systems and components. For example, various implementations may include one or more of the following technical effects, advantages, and/or improvements: 1) non-routine and unconventional use of a touch device to provide input for a secondary wearable or XR device; and 2) non-routine and unconventional operations to switch from providing touch input to the touch device to providing input to the wearable or XR device.

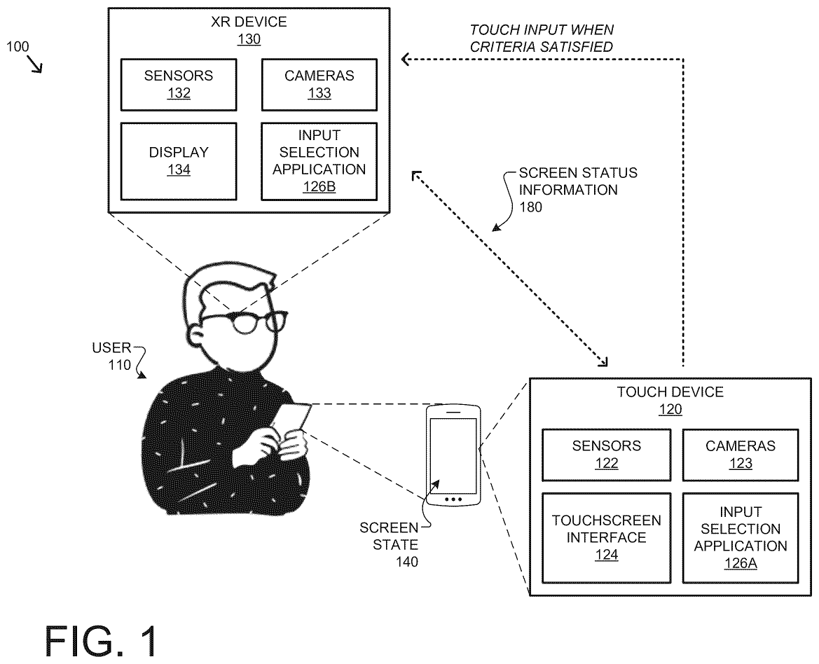

FIG. 1 illustrates a system 100 for assigning touch input based on screen state according to an implementation. System 100 includes user 110, touch device 120, XR device 130, screen state 140, and screen status information 180, which may be exchanged between the devices. Touch device 120 further includes sensors 122, cameras 123, and touchscreen interface 124. XR device 130 further includes sensors 132, cameras 133, and display 134. Touch device 120 and XR device 130 provide input selection applications 126A-126B. Although demonstrated as being distributed in the example of system 100 as input selection applications 126A-126B, similar operations may be performed locally at each of the devices. Input selection applications 126A-126B may comprise a function or a set of functions that execute (e.g., run) in the background to support the touch input arbitration to different. The application may not have a user interface in some examples. Although demonstrated as an XR device, touch device 120 may comprise other types of computing devices or companion devices in some examples.

Input selection applications 126A-126B identify the screen state 140 associated with touch device 120 and assign touch input to touch device 120 or XR device 130 based on screen state 140. In at least one technical solution, touch device 120 identifies screen state 140 associated with the device. The screen state 140 may be indicative of whether the touch device 120 is in an active state or an inactive state. When screen state 140 indicates that touchscreen interface 124 is in an active state for user 110, then touch input at touchscreen interface 124 is provided to applications and executables on touch device 120. When screen state 140 indicates that touchscreen interface 124 is inactive for user 110, then touch input at touchscreen interface 124 is provided to applications and executables on XR device 130.

In some implementations, the screen state 140 of touch device 120 may be considered active when the screen is turned on and actively presenting content (e.g., an application) that is visible to user 110. This could include scenarios where the display is showing images, videos, text, or any other form of visual information. In some examples, screen state 140 may provide an indication of whether an application is open for display on the first device. When an application is open, the screen may be considered active.

The screen of touch device 120 may be considered inactive when it is not actively presenting content or when it is powered off. The screen may also be considered inactive when the device is presenting a screen saver or is placed in an always-on mode. Always-on mode refers to a state where touch device 120 remains powered and operational continuously, typically to provide instant access to information or functionality without the need for user interaction to activate. For example, screen state 140 may be considered inactive when displaying the time as part of a power saving mode of touch device 120. In some implementations, when screen state 140 indicates that the display or screen is inactive (i.e., the at least one criterion is satisfied), touch input from touchscreen interface 124 is provided to XR device 130. The touch input may include tapping, swiping, pinching, scrolling, or some other touch input to perform actions or manipulate content presented on display 134.

In some implementations, other state information associated with touch device 120 or XR device 130 may be considered in arbitrating the touch input from touch device 120. In at least one example, the input selection application will identify screen activity information that corresponds to a first touch input from user 110. Specifically, the screen activity information may determine whether the first touch input corresponds to or interacts with content presented on touch device 120. For example, when user 110 provides a tap input on touchscreen interface 124, the input selection application 126A-126B may determine whether the tap input interacts with content displayed on touch device 120. When the tap input does not interact with content on touch device 120, then touch input may be directed to XR device 130.

In some implementations, input selection application 126A-126B may use state information provided by both touch device 120 and XR device 130 to determine whether at least one criterion is met that directs touch input to XR device 130 from touch device 120. In some examples, the state information from XR device 130 may indicate whether an application associated with touch input is displayed as content on XR device 130. For example, while a first application on XR device 130 may be associated with touch input, another application may not be configured or associated with touch input. The status for touch device 120 may include the screen state (e.g., device in an active or an inactive state), the touch state (whether a touch corresponded to content presented on touch device 120), or some other state information. The state information from both devices can be compared to criteria to assign the touch input to either touch device 120 or XR device 130. As an illustrative example, the criteria may require content on the XR device to be associated with (or permit) touch input and may require that the touch screen activity indicate that touch input at touch device 120 does not correspond to content displayed on touchscreen interface 124. When both criteria are satisfied, the touch input at touch device 120 may be forwarded to XR device 130 via a communication protocol (e.g., Bluetooth or Wi-Fi).

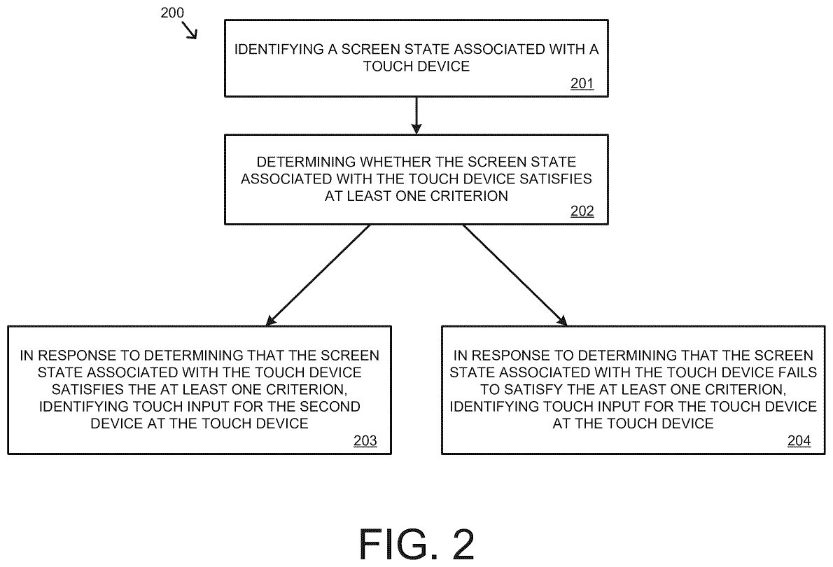

FIG. 2 illustrates a method 200 of assigning touch input based on screen state of a touch device according to an implementation. The steps of method 200 are described below with reference to the elements of system 100 of FIG. 1. Method 200 may be performed by an application on touch device 120, XR device 130, or some combination thereof.

Method 200 includes identifying a screen state associated with a touch device at step 201, and determining whether the screen state associated with the touch device satisfies at least one criterion at step 202. In some implementations the screen state for a device, such as touch device 120, indicates whether the touchscreen interface 124 is active or inactive and the at least one criterion is satisfied when the touchscreen interface 124 is in the inactive state. A screen or display may be considered active when it is displaying content and responding to user interactions, such as touch inputs or button presses. In other words, if the screen is illuminated and capable of receiving and processing user input, it can be considered active. A screen may be considered inactive when it is not displaying any content or when it is in a standby mode, awaiting user interaction. Additionally, if the screen is displaying content but is unresponsive to touch inputs or other user interactions for an extended period, it can also be regarded as inactive. For example, when the screen is in a standby or off mode, then the screen can be considered inactive. In some examples, this inactive state may exist when user 110 has touch device 120 locked, preventing user 110 from inadvertently providing input in association with an application on touch device 120. Alternatively, this may exist when the user has not touched touch device 120 within a period, preventing inadvertent input associated with touch device 120. In some implementations, touchscreen interface 124 may be active when it is powered on and displaying content for user interaction.

In response to determining that the screen state associated with the touch device satisfies the at least one criterion, method 200 further includes identifying touch input for a second device at the touch device at step 203. In some implementations, when the display of touchscreen interface 124 is determined to be inactive, then touch input is communicated from touch device 120 to XR device 130. Touch input may include tapping, swiping, pinching, or some other touch input to perform actions or manipulate content. For example, a user may touch touchscreen interface 124 to move a cursor and select objects displayed as part of display 134 on XR device 130. In some implementations, the communication from touch device 120 may comprise touch Bluetooth, Wi-Fi, or some other wireless communication standard.

In response to determining that the screen state associated with the touch device fails to satisfy the at least one criterion, method 200 further includes identifying touch input for the touch device at the touch device at step 204. In some implementations, when the display of touchscreen interface 124 is active, touch input on touchscreen interface 124 is provided to applications local to touch device 120. The touch input may include tapping, swiping, pinching, or some other touch input to perform actions or manipulate content. For example, the user may use a swiping gesture to navigate a list of images on touch device 120.

In some implementations, in addition to or in place of the screen state information described above, an application that arbitrates touch input may consider other factors. In one implementation, the application may determine a touch status from user 110. The touch status indicates whether the touch is targeted at an object on touch device 120 or is unrelated to the content being displayed on touch device 120. For example, touch device 120 may identify touch input from user 110. The application may determine whether the touch input corresponds to a content displayed on the device or is unrelated to the content on the device. For example, user 110 may provide a tap input on touchscreen interface 124 that does not correspond to an object or button on touch device 120. Accordingly, the application may determine that at least one criterion is satisfied and may direct the touch input to XR device 130. In another example, user 110 may provide a tap input on touchscreen interface 124 that corresponds to a button displayed on touch device 120. In this example, the application may determine that the at least one criterion is not satisfied and may direct the touch input to touch device 120 to navigate or interact with the device's interface or content.

In some implementations, when the at least one criterion is satisfied, the touch input directed to XR device 130 will be maintained until the user provides input indicating that the touch input is no longer desired. For example, the user may select an option or button as part of the display from XR device 130 to end providing touch input from touch device 120 to XR device 130. In other implementations, the touch input will monitor the at least one criterion to determine when to revert the touch input to touch device 120. For example, at a first time, the screen state for touch device 120 may satisfy first criterion indicative of the screen being in an inactive state. Accordingly, first touch input will be provided to XR device 130. At a second time, the screen state will fail to satisfy the at least one criterion (e.g., a notification was delivered). When the screen state fails to satisfy the at least one criterion, the touch input will be directed to touch device 120.

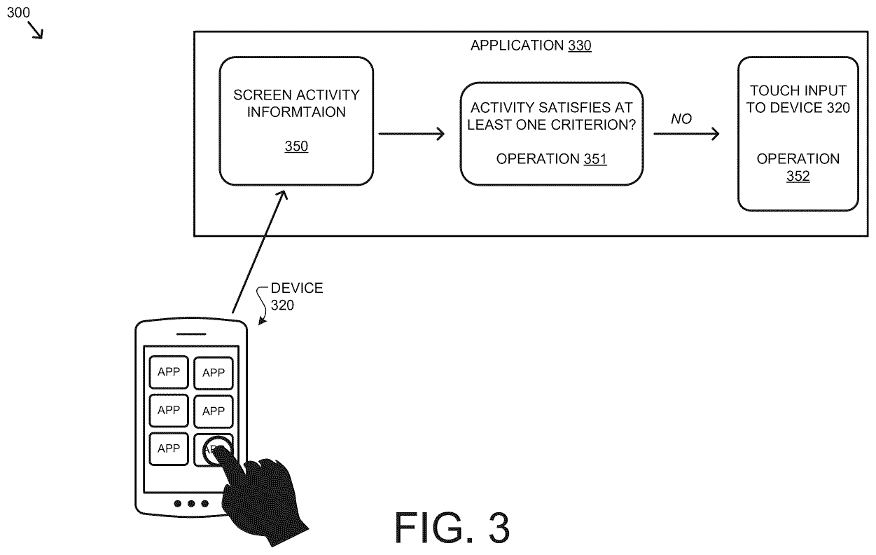

FIG. 3 illustrates an operational scenario 300 of assigning touch input from a touch device according to an implementation. Operational scenario 300 includes device 320, and application 330. Application 330 includes operations 350-352. Application 330 may be executed on device 320, on a second device (e.g., XR device), or some combination thereof.

In operational scenario 300 application 330 performs operation 350 to identify screen activity information associated with device 320. In some examples, the screen activity information includes screen state information. Screen state information indicates whether the screen is active or inactive. A screen may be considered active when it is powered on and displaying content. This includes situations where the screen is actively showing information, graphics, or responding to user inputs. For example, a screen may be considered active when it is displaying content of an application or the home screen. A screen may be considered inactive when it is powered off, in a sleep state, or providing display of an always on screen (e.g., a clock).

In some implementations, the screen activity information further includes information about the touch state or a most recent touch. The touch state indicates whether one or more recent touch inputs from the user correspond to objects or applications displayed on device 320 or are unrelated to objects or applications displayed on device 320. For example, the touch state may indicate that a most recent tap corresponds to a button displayed as part of an application. In another example, the touch state may indicate that a touch input to scroll does not correspond to an application displayed on device 320. Here, in the example of operational scenario 300, the user selects or taps an application displayed on device 320.

From screen activity information, application 330 performs operation 351 that determines whether the screen activity information satisfies at least one criterion. In some implementations, the at least one criterion includes an indication that the screen state is inactive. In some implementations, the at least one criterion includes an indication that the most recent touch input does not correspond to an application displayed on device 320. Once it is determined that the at least one criterion is not satisfied, then operation 352 is performed that directs touch input at device 320 to device 320.

Although demonstrated in the previous example as directing touch input between devices, similar operations may be performed to direct other inputs or outputs to either device 320 or a second device, such as an XR device. In at least one implementation, when the at least one criterion is satisfied, application 330 may direct notifications to be displayed on the second device over device 320. A notification is a brief message or alert delivered by a device or application to inform the user about a specific event or update. The notification may comprise a text message, an email, an application update, or some other event or update. In at least one implementation, when the at least one criterion is not satisfied, application 330 may direct notifications to be displayed on the device 320. In another implementation, application 330 may direct voice input to either device 320 or the second device based on whether the at least one criterion is satisfied. For example, when the at least one criterion is satisfied, voice input may be received at the second device (i.e., XR device) over device 320. Alternatively, when the at least one criterion is not satisfied, voice input may be received at device 320. The technical effect is that input is received or identified at one device based on the screen activity information in relation to the criterion.

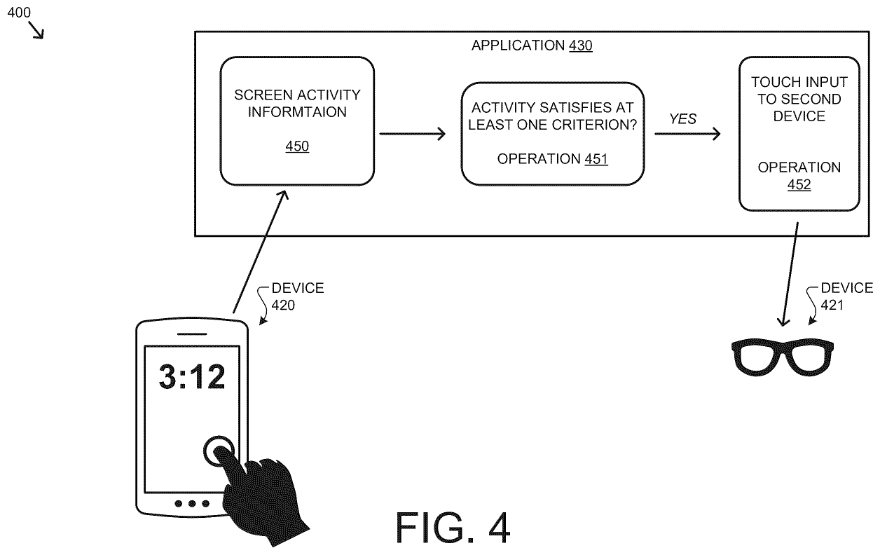

FIG. 4 illustrates an operational scenario 400 of assigning touch input from a touch device according to an implementation. Operational scenario 400 includes device 420, device 421, and application 430. Application 430 includes operations 450-452. Application 430 may be executed on device 420, device 421 (e.g., XR device), or some combination thereof.

In operational scenario 400 application 430 performs operation 450 to identify screen activity information associated with device 420. In some examples, the screen activity information includes screen state information. Screen state information indicates whether the screen is active or inactive. A screen may be considered active when it is powered on and displaying content. This includes situations where the screen is actively showing information, graphics, or responding to user inputs. For example, a screen may be considered active when it is displaying content of an application or the home screen. A screen may be considered inactive when it is powered off, in a sleep state, or providing display of an always on screen (e.g., a clock).

In some implementations, the screen activity information further includes information about the touch state or a most recent touch. The touch state indicates whether one or more recent touch inputs from the user correspond to objects or applications displayed on device 420 or are unrelated to objects or applications displayed on device 420. For example, the touch state may indicate that a most recent tap corresponds to a button displayed as part of an application. In another example, the touch state may indicate that a touch input to scroll does not correspond to an application displayed on device 420. Here, in the example of operational scenario 400, the user touches the screen in an open space that does not correspond to an application. In at least one example, the touch may correspond to a lock screen. In another example, the touch may correspond to a screen that is off or in a sleep state.

Once screen activity information is identified, operation 451 is performed that determines whether the screen activity information satisfies at least one criterion. In some implementations, the criterion corresponds to the screen being in an inactive state. In some implementations, the criterion includes the recent touch inputs being unrelated to content or an application being displayed on device 420. In some implementations, the at least one criterion includes multiple criteria, such as a required screen state (e.g., inactive) and a required determination that a touch is not directed to content displayed on device 420.

Here, operation 451 determines that the at least one criterion is met, and operation 452 is used to direct touch input from device 420 to device 421. Touch inputs refer to interactions with device 420 using physical contact, such as tapping, swiping, pinching, or dragging, to navigate, select, or manipulate on-screen elements of device 421. These inputs are converted into digital signals by a touch-sensitive surface on device 420, enabling users to interact with and control various functions and features for device 421. The touch inputs at device 420 may be provided via a wireless communication protocol to device 421. For example, the touch inputs may be used to navigate a cursor displayed on device 421.

Although demonstrated in the previous example as directing touch input between devices, similar operations may be performed to direct other inputs or outputs to either device 420 or device 421. In at least one implementation, when the at least one criterion is satisfied, application 430 may direct notifications to be displayed on the device 421 over device 420. A notification is a brief message or alert delivered by a device or application to inform the user about a specific event or update. The notification may comprise a text message, an email, an application update, or some other event or update. In at least one implementation, when the at least one criterion is not satisfied, application 430 may direct notifications to be displayed on the device 420. In another implementation, application 430 may direct voice input to either device 420 or device 421 based on whether the at least one criterion is satisfied. For example, when the at least one criterion is satisfied, voice input may be received or identified at device 421 (i.e., XR device) over device 320. Alternatively, when the at least one criterion is not satisfied, voice input may be received or identified at device 420. The technical effect is that input is received at one device based on the screen activity information in relation to the criterion. Advantageously, the devices do not compete to receive and process the voice input.

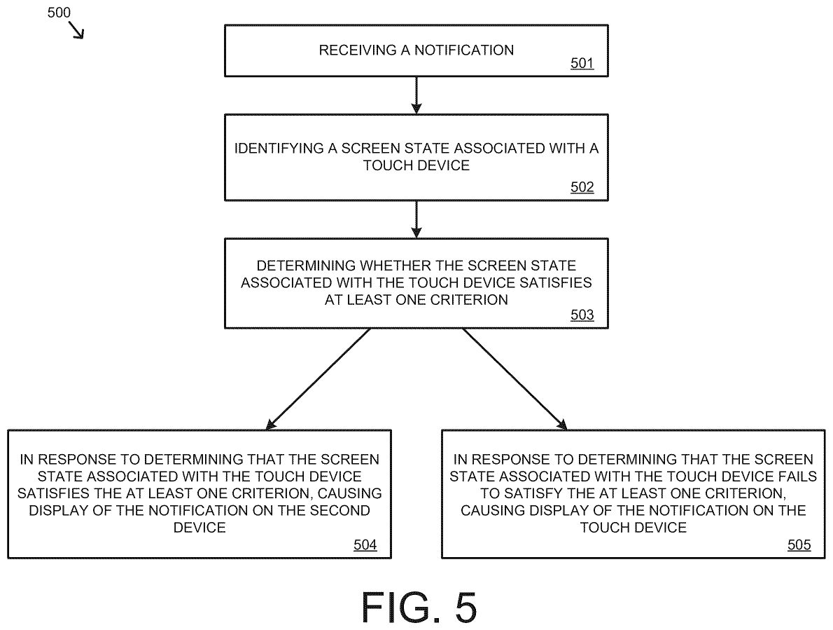

FIG. 5 illustrates a method 500 of displaying notifications based on the screen state of a touch device according to an implementation. Method 500 may be performed by a companion device (i.e., touch device, such as a smartphone, smartwatch, tablet, and the like), may be performed by a wearable device (e.g., XR device), or may be performed by some combination thereof.

Method 500 includes identifying a notification at step 501. A notification is a brief message or alert from a device or application that informs the user about a specific event, update, or action that requires their attention. A notification may comprise Method 500 further includes identifying a screen state associated with a touch device at step 502 and determining whether the screen state associated with the touch device satisfies at least one criterion at step 503. In at least one implementation, the screen state indicates whether the screen is active or inactive. The screen may be considered active when it is powered on, displaying content, and responsive to user interactions, such as touch inputs. A screen may be considered inactive when it is powered off or not displaying any content, and it does not respond to user inputs or interactions. In some implementations, a screen may be considered inactive when it is in an always on state (e.g., displaying the time as part of a lock screen). In some implementations, the at least one criterion includes a requirement that the screen is in an inactive state.

Method 500 further includes, in response to determining that the screen state associated with the touch device satisfies the at least one criterion, causing display of the notification on the second device at step 504. Alternatively, in response to determining that the screen state associated with the touch devices fails to satisfy the at least one criterion, method 500 provides for causing display of the notification on the touch device at step 505. Although demonstrated in method 500 using a displayed notification, the notification may comprise an audio notification that is played via speakers on either the touch device or the second device.

In some implementations, in addition to or in place of directing the display of the notification to the touch device or the second device based on the screen status, an application may direct the notification to a device based on one or more recent touch inputs. For example, the application may monitor a recent touch input to determine whether the touch input satisfies at least one criterion. In some implementations, the at least one criterion includes the recent touch input being unrelated to an application displayed on the touch device. For example, if the user provides touch input indicating a scroll, but a scroll touch input is not available or unrelated for the open application on the touch device, then the touch input may be directed to the XR device. Alternatively, if the user provides touch input corresponding to a tap on a button displayed as part of an application on the touch device, then the touch input will be directed to the touch device. The technical effect permits touch inputs that do not correlate to the application or displayed content of the touch device to be communicated to the second device. Consequently, the touch device can provide touch inputs for both the touch device itself and a secondary device.

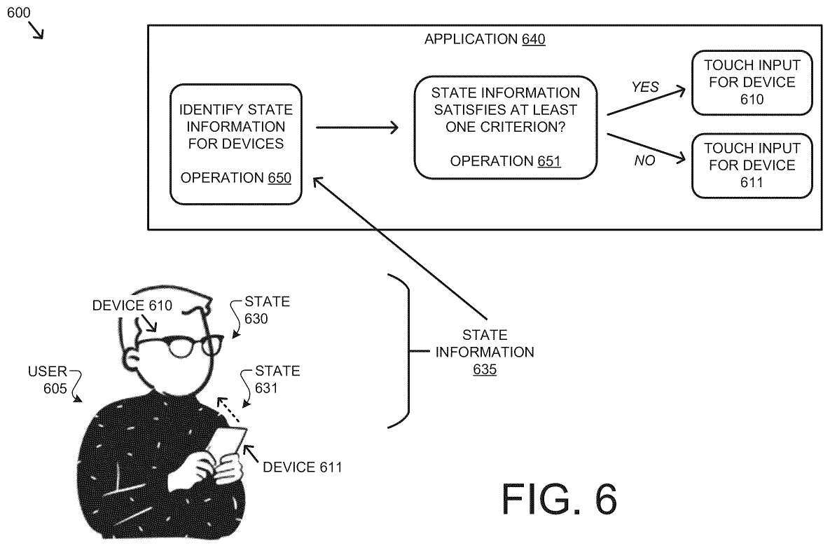

FIG. 6 illustrates an operational scenario 600 of assigning touch input based on screen state and application state of devices according to an implementation. Operational scenario 600 includes user 605, device 610, device 611, state 630, state 631, state information 635, and application 640. Application 640 provides operations 650-651. Application 640 may be implemented on device 610, device 611, or some combination thereof.

In operational scenario 600, application 640 provides operation 650 that identifies state information 635 for devices 610-611. State information 635 includes state 630 that corresponds to device 610 and state 631 that corresponds to device 611. State 630 may indicate applications executing on device 610, a current display for content on device 610, or some other state information. For example, state 630 may indicate the applications that are executing and displayed as part of content on the display of device 610. State 631 may indicate a screen state associated with device 611, may indicate one or more recent touch inputs associated with device 611, or may provide some other information in association with the state of device 611. For example, state 631 may indicate that device 611 is actively displaying content of an application (e.g., email application) and may indicate that the most recent touch input corresponds to a scroll of the application.

Once state information 635 is identified, application 640 determines whether the state information satisfies at least one criterion using operation 651. In some implementations, the at least one criterion includes determining whether an application is currently displayed on device 610 is associated with touch input. When an application on device 610 is associated with touch input, then it may be desirable for application 640 to direct touch input to device 610. In some implementations, the at least one criterion includes determining whether the screen state for device 611 is in an inactive state. In some examples, the screen or display of device 611 is considered inactive when it is not actively showing content or responding to user input. The screen may be considered inactive when the screen is off, when the screen is in an always-on mode (always-on mode refers to a device state where certain functions or displays remain continuously active, typically to provide constant access to information or features without requiring user interaction to activate them), or when the screen is displaying a lock screen. When the screen state for device 611 indicates that the screen is inactive, then touch inputs from device 611 can be directed to device 610. In some implementations, the at least one criterion may correspond to a first touch at device 611 not being directed to content displayed on device 611. For example, a touch input to scroll on content that is not scrollable may indicate that the touch is directed to content on device 610. Accordingly, when the touch input does not correspond to content on device 611, the touch may be directed to device 610. In some examples, the at least one criterion may represent any combination of the examples provided above. When the at least one criterion is satisfied, touch input from device 611 is directed to device 610. Alternatively, when the at least one criterion is not satisfied, touch input from device 611 is directed to device 611.

The touch input identified on device 611 refers to the ability to interact with content on either device 610 or device 611 by directly touching the screen of device 611, enabling users to perform various actions such as tapping, swiping, or pinching to navigate, select, or manipulate content. It can utilize capacitive sensors embedded in the screen to detect the presence and location of touch, translating these inputs into commands or actions within the software of device 610 or device 611.

Although demonstrated in the previous example as directing touch input at device 611 to either device 610 or device 611 based on state information 635, similar operations may be used to direct input or output to either device based on state information 635. In some implementations, notifications may be directed to either device 610 or device 611 based on the state information 635 satisfying the at least one criterion. In some implementations, voice input may be directed to either device 610 or device 611 based on the state information 635 satisfying the at least one criterion. For example, when the at least one criterion is satisfied, the voice input may be received and processed using device 610. Alternatively, when the at least one criterion is not satisfied, the voice input may be received and processed using device 611. Advantageously, one of the devices is selected to process the voice input based on the current state information 635.

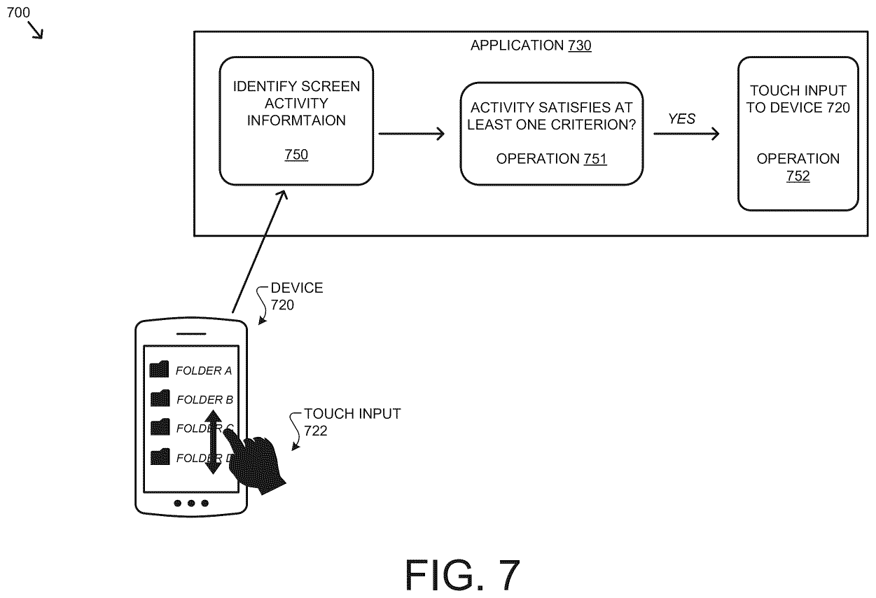

FIG. 7 illustrates an operational scenario 700 of assigning input based on recent touch input according to an implementation. Operational scenario 700 includes device 720, touch input 722, and application 730. Application 730 provides operations 750-752. Application 730 may be implemented on device 720, a second device (not pictured), or some combination thereof.

In operational scenario 700, application 730 and operation 750 identifies screen activity information associated with device 720. In some implementations, the screen activity information corresponds to information about one or more touch inputs identified by device 720, such as touch input 722. The information about one or more touch inputs may indicate the type of touch (e.g., tap, scroll, pinch), the location of the touch on the screen, a determination of whether the touch manipulated content associated with an application executing on device 720, or some other information. From screen activity information, application 730 determines whether the activity satisfies at least one criterion using operation 751. In at least one implementation, application 730 determines whether touch input 722 satisfies at least one criterion. In some examples, the at least one criterion includes touch input 722 being unrelated to content displayed by device 720. When the touch input is unrelated, such as when the user taps a portion of the display that does not include interactive content, then application 730 will direct touch input from device 720 to a second device, such as an XR device. Alternatively, when the touch is related to content displayed by device 720, then the touch input may be directed to device 720. Here, touch input 722 is used to scroll files on device 720. Application 730 determines that the scroll is related to the content displayed on device 720 directs touch input to device 720 via operation 752.

Although demonstrated in the previous example as directing touch input based on the screen activity associated with device 720, similar operations may be used to direct input or output to either device based on state information 635. In some implementations, notifications may be directed to device 720 or the second device (i.e., XR device) based on the screen activity satisfying the at least one criterion. In some implementations, voice input may be directed to device 720 or the second device (i.e., XR device) based on the screen activity information satisfying the at least one criterion. For example, when the at least one criterion is satisfied, the voice input may be received and processed using an XR device. Alternatively, when the at least one criterion is not satisfied, the voice input may be received and processed using device 720. Advantageously, one of the devices is selected to process the voice input based on the current screen activity detected in association with device 720.

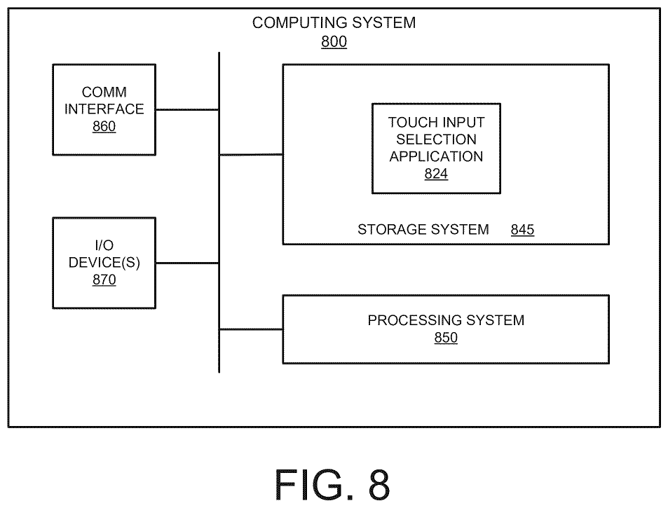

FIG. 8 illustrates a computing system 800 to assign touch input based at least on the screen state according to an implementation. Computing system 800 is representative of any computing system or systems with which the various operational architectures, processes, scenarios, and sequences disclosed herein for assigning touch inputs to different devices may be implemented. Computing system 800 may be an example of an XR device, a touch device, or a combination of an XR device and touch device as described herein. Computing system 800 includes storage system 845, processing system 850, communication interface 860, input/output (I/O) device(s) 870. Processing system 850 is operatively linked to communication interface 860, I/O device(s) 870, and storage system 845. Communication interface 860 and/or I/O device(s) 870 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency, processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format-including combinations thereof. Communication interface 860 may be configured to communicate with external devices, such as servers, user devices, or some other computing device.

I/O device(s) 870 may include peripherals of a computer that facilitate the interaction between the user and computing system 800. Examples of I/O device(s) 870 may include keyboards, mice, trackpads, monitors, displays, printers, cameras, microphones, external storage devices, and the like.

Processing system 850 comprises microprocessor circuitry (e.g., at least one processor) and other circuitry that retrieves and executes operating software (i.e., program instructions) from storage system 845. Storage system 845 may include volatile and nonvolatile, removable, and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media (also referred to as computer readable storage media) include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 850 is typically mounted on a circuit board that may also hold the storage system. The operating software of storage system 845 comprises computer programs, firmware, or some other form of machine-readable program instructions. The operating software of storage system 845 comprises touch input selection application 824. The operating software on storage system 845 may further include an operating system, utilities, drivers, network interfaces, applications, or some other type of software. When read and executed by processing system 850 the operating software on storage system 845 directs computing system 800 to operate as a computing device as described herein. In at least one implementation, the operating software can provide at least method 200 described in FIG. 2.

In at least one example, touch input selection application 824 directs processing system 850 to identify a screen state associated with a first device (e.g., a companion device or touch device) and determine whether the screen state associated with the first device satisfies at least one criterion. In some implementations, the screen state indicates whether the screen is active or inactive. A screen may be considered active when it is displaying content and receiving input from a user or system. For example, the screen is active when it is lit up and the user can see and interact with the displayed content. Conversely, a screen is inactive when it is turned off or in a standby mode where it's not displaying anything or responding to input. A screen may also be considered in active when it is in an always-on state. In some implementations, the screen state indicates whether an application is open for display on the first device. For example, the screen state may indicate whether the user is actively viewing or interacting with an application on the first device.

In response to determining that the screen state associated with the first device satisfies the at least one criterion, touch input selection application 824 directs processing system 850 to identify touch input for a second device at the first device. For example, when the criteria are satisfied touch input from a touch device (e.g., smartphone) can be provided to a second device (e.g., XR device). Touch input includes users physically interacting with the screen through gestures like tapping, swiping, and pinching to navigate, select, and manipulate content and functions that are displayed on the second device (i.e., XR device).

In an alternative example, in response to determining that the screen state associated with the first device fails to satisfy the at least one criterion, touch input selection application 824 directs processing system 850 to identify touch input for the first device at the first device. For example, the screen state may indicate that content for an application is actively being displayed on the touch device. Consequently, touch input identified or received at the touch device will be directed to the touch device and the corresponding content. Touch input includes users physically interacting with the screen through gestures like tapping, swiping, and pinching to navigate, select, and manipulate content and functions that are displayed on the touch device.

Although demonstrated in the previous example as assigning touch input, similar operations can be performed to arbitrate various inputs or outputs. In one example, when the at least criterion is satisfied, notifications may be provided to the XR device over the touch device. In another example, when the at least one criterion is satisfied, voice input may be received and processed using the XR device in place of the touch device.

In some implementations, in addition to or in place of identifying the screen state, touch input selection application 824 may identify other factors to arbitrate touch input to either the touch device or the second device (XR device). In one example, a factor may include screen activity information related to a touch input to the touch device. The screen activity information may indicate whether a touch is related to content being displayed on the touch device or unrelated to content on the touch device. The at least one criterion may include a requirement that the touch be unrelated to content on the touch device. When the at least one criterion is satisfied, the touch input may be directed to the XR device. However, when the at least one criterion is not satisfied, the touch input may be directed to the touch device. As a technical effect, when touch input is unrelated to content on the touch device (e.g., does not correspond to a button or object displayed on the touch device), the touch input may be provided to the XR device to support applications on the XR device.

In some examples, a factor may include status information associated with the XR device. The status information may identify one or more applications or content on the display of the XR device. If the content is associated with touch input (e.g., an application that would benefit from touch input), then touch input may be directed to the XR device. However, if the content is not associated with touch input (e.g., is not configured for touch input or a preference is configured to not use touch input), then touch input may not be directed to the XR device. Although the various factors are described individually in the examples above, some versions of touch input selection application 824 may use any number of the factors to arbitrate touch input (or other input/output) as described herein. In at least one implementation, touch input selection application 824 may determine whether content on the XR device is associated with touch input and may determine whether the screen state is inactive on the touch device. When both conditions are satisfied (e.g., content is associated with touch input and the screen state is inactive), then touch input may be provided to the XR device.

Clause 1. A method comprising: identifying a screen state associated with a first device; determining whether the screen state associated with the first device satisfies at least one criterion; in response to determining that the screen state associated with the first device satisfies the at least one criterion, identifying touch input for a second device at the first device; and in response to determining that the screen state associated with the first device fails to satisfy the at least one criterion, identifying touch input for the first device at the first device.

Clause 2. The method of clause 1, wherein the screen state includes an indication of whether a screen on the first device is in an active state or an inactive state.

Clause 3. The method of clause 1, wherein the screen state includes an indication of whether an application is open for display on the first device.

Clause 4. The method of clause 1 further comprising: identifying a notification; in response to determining that the screen state associated with the first device satisfies the at least one criterion, causing display of the notification on the second device; and in response to determining that the screen state associated with the first device fails to satisfy the at least one criterion, causing display of the notification on the first device.

Clause 5. The method of clause 1 further comprising: identifying a first touch input on the first device; wherein determining whether the screen state associated with the first device satisfies the at least one criterion comprises determining whether the screen state associated with the first device and the first touch input satisfies the at least one criterion.

Clause 6. The method of clause 5, wherein the at least one criterion includes the first touch input being unrelated to content displayed on the first device.

Clause 7. The method of clause 1, wherein the second device comprises an extended reality device, and wherein the first device comprises a companion device.

Clause 8. A computing system comprising: a computer-readable storage medium; at least one processor operatively coupled to the computer-readable storage medium; and program instructions stored on the computer-readable storage medium that, when executed by the at least one processor, direct the at least one processor to: identify a screen state associated with a first device; determine that the screen state associated with the first device satisfies at least one criterion; in response to determining that the screen state associated with the first device satisfies the at least one criterion, identify touch input for a second device at the first device; and in response to determining that the screen state associated with the first device fails to satisfy the at least one criterion, identify touch input for the first device at the first device.

Clause 9. The computing system of clause 8, wherein the screen state includes an indication of whether a screen on the first device is in an active state or an inactive state.

Clause 10. The computing system of clause 8, wherein the screen state includes an indication of whether an application is open for display on the first device.

Clause 11. The computing system of clause 8, wherein the program instructions further direct the at least one processor to: identify a notification; in response to determining that the screen state associated with the first device satisfies the at least one criterion, cause display of the notification on the second device; and in response to determining that the screen state associated with the first device fails to satisfy the at least one criterion, cause display of the notification on the first device.

Clause 12. The computing system of clause 8, wherein the program instructions further direct the at least one processor to: identify a first touch input on the first device; wherein determining whether the screen state associated with the first device satisfies the at least one criterion comprises determining whether the screen state associated with the first device and the first touch input satisfies the at least one criterion.

Clause 13. The computing system of clause 12, wherein the at least one criterion includes the first touch input being unrelated to content displayed on the first device.

Clause 14. The computing system of clause 8, wherein the second device comprises an extended reality device, and wherein the first device comprises a companion device.

Clause 15. A computer-readable storage medium having program instructions stored thereon that, when executed by at least one processor, cause the at least one processor to execute operations, the operations comprising: identifying a screen state associated with a first device; determining whether the screen state associated with the first device satisfies at least one criterion; in response to determining that the screen state associated with the first device satisfies the at least one criterion, identifying touch input for a second device at the first device; and in response to determining that the screen state associated with the first device fails to satisfy the at least one criterion, identifying touch input for the first device at the first device.

Clause 16. The computer-readable storage medium of clause 15, wherein the screen state includes an indication of whether a screen on the first device is in an active state or an inactive state.

Clause 17. The computer-readable storage medium of clause 15, wherein the screen state includes an indication of whether an application is open for display on the first device.

Clause 18. The computer-readable storage medium of clause 15, wherein the operations further comprise: identifying a notification; in response to determining that the screen state associated with the first device satisfies the at least one criterion, causing display of the notification on the second device; and in response to determining that the screen state associated with the first device fails to satisfy the at least one criterion, causing display of the notification on the first device.

Clause 19. The computer-readable storage medium of clause 15, wherein the operations further comprise: identifying a first touch input on the first device; wherein determining whether the screen state associated with the first device satisfies the at least one criterion comprises determining whether the screen state associated with the first device and the first touch input satisfies the at least one criterion.

Clause 20. The computer-readable storage medium of clause 19, wherein the at least one criterion includes the first touch input being unrelated to content displayed on the first device.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that the terminology employed herein is for the purpose of describing aspects and is not intended to be limiting. On the contrary, this patent covers all methods, apparatus and articles of manufacture fairly falling within the scope of the claims of this patent.

What is claimed is:

1. A method comprising:
identifying a screen state associated with a first device;
determining whether the screen state associated with the first device satisfies at least one criterion;
in response to determining that the screen state associated with the first device satisfies the at least one criterion, identifying touch input for a second device at the first device; and
in response to determining that the screen state associated with the first device fails to satisfy the at least one criterion, identifying touch input for the first device at the first device.

2. The method of claim 1, wherein the screen state includes an indication of whether a screen on the first device is in an active state or an inactive state.

3. The method of claim 1, wherein the screen state includes an indication of whether an application is open for display on the first device.

4. The method of claim 1 further comprising:
identifying a notification;
in response to determining that the screen state associated with the first device satisfies the at least one criterion, causing display of the notification on the second device; and
in response to determining that the screen state associated with the first device fails to satisfy the at least one criterion, causing display of the notification on the first device.

5. The method of claim 1 further comprising:
identifying a first touch input on the first device;
wherein determining whether the screen state associated with the first device satisfies the at least one criterion comprises determining whether the screen state associated with the first device and the first touch input satisfies the at least one criterion.

6. The method of claim 5, wherein the at least one criterion includes the first touch input being unrelated to content displayed on the first device.

7. The method of claim 1, wherein the second device comprises an extended reality device, and wherein the first device comprises a companion device.

8. A computing system comprising:
a computer-readable storage medium;
at least one processor operatively coupled to the computer-readable storage medium; and
program instructions stored on the computer-readable storage medium that, when executed by the at least one processor, direct the at least one processor to:
identify a screen state associated with a first device;
determine that the screen state associated with the first device satisfies at least one criterion;
in response to determining that the screen state associated with the first device satisfies the at least one criterion, identify touch input for a second device at the first device; and
in response to determining that the screen state associated with the first device fails to satisfy the at least one criterion, identify touch input for the first device at the first device.

9. The computing system of claim 8, wherein the screen state includes an indication of whether a screen on the first device is in an active state or an inactive state.

10. The computing system of claim 8, wherein the screen state includes an indication of whether an application is open for display on the first device.

11. The computing system of claim 8, wherein the program instructions further direct the at least one processor to:
identify a notification;
in response to determining that the screen state associated with the first device satisfies the at least one criterion, cause display of the notification on the second device; and
in response to determining that the screen state associated with the first device fails to satisfy the at least one criterion, cause display of the notification on the first device.

12. The computing system of claim 8, wherein the program instructions further direct the at least one processor to:
identify a first touch input on the first device;
wherein determining whether the screen state associated with the first device satisfies the at least one criterion comprises determining whether the screen state associated with the first device and the first touch input satisfies the at least one criterion.

13. The computing system of claim 12, wherein the at least one criterion includes the first touch input being unrelated to content displayed on the first device.

14. The computing system of claim 8, wherein the second device comprises an extended reality device, and wherein the first device comprises a companion device.

15. A computer-readable storage medium having program instructions stored thereon that, when executed by at least one processor, cause the at least one processor to execute operations, the operations comprising:
identifying a screen state associated with a first device;
determining whether the screen state associated with the first device satisfies at least one criterion;
in response to determining that the screen state associated with the first device satisfies the at least one criterion, identifying touch input for a second device at the first device; and
in response to determining that the screen state associated with the first device fails to satisfy the at least one criterion, identifying touch input for the first device at the first device.

16. The computer-readable storage medium of claim 15, wherein the screen state includes an indication of whether a screen on the first device is in an active state or an inactive state.

17. The computer-readable storage medium of claim 15, wherein the screen state includes an indication of whether an application is open for display on the first device.

18. The computer-readable storage medium of claim 15, wherein the operations further comprise:
identifying a notification;
in response to determining that the screen state associated with the first device satisfies the at least one criterion, causing display of the notification on the second device; and
in response to determining that the screen state associated with the first device fails to satisfy the at least one criterion, causing display of the notification on the first device.

19. The computer-readable storage medium of claim 15, wherein the operations further comprise:
identifying a first touch input on the first device;
wherein determining whether the screen state associated with the first device satisfies the at least one criterion comprises determining whether the screen state associated with the first device and the first touch input satisfies the at least one criterion.

20. The computer-readable storage medium of claim 19, wherein the at least one criterion includes the first touch input being unrelated to content displayed on the first device.
